(19) United States
(12) Patent Application Publication
(10) Pub. No.: US 2017/0317373 A1
(43) Pub. Date: Nov. 2, 2017

(54) ELECTRO-CHEMICAL UNIT FOR A FUEL CELL STACK

(71) Applicant: ElringKlinger AG, Dettingen (DE)

(72) Inventors: Peter Stahl, Metzingen (DE); Juergen Kraft, Metzingen (DE); Michael Goetz, Dettingen (DE)

(21) Appl. No.: 15/654,314

(22) Filed: Jul. 19, 2017

Related U.S. Application Data
(63) Continuation of application No. PCT/EP2016/051003, filed on Jan. 19, 2016.

(30) Foreign Application Priority Data
Jan. 20, 2015 (DE) 10 2015 100 740.1

(51) Int. Cl. H01M 8/2485; H01M 8/04; H01M 8/0271; H01M 8/248

(52) U.S. Cl. CPC H01M 8/2485; H01M 8/248; H01M 8/04; H01M 8/0271

(57) ABSTRACT

In order to produce an electro-chemical unit for a fuel cell stack in which a plurality of electro-chemical units follow one another along a stacking direction wherein the electro-chemical unit includes a membrane electrode unit having an anode-side electro-chemically active surface which has an outer border that is defined by an anode-side bordering element and wherein the electro-chemical unit also includes a cathode-side electro-chemically active surface which has an outer border that is defined by a cathode-side bordering element in such a way as to prevent enhanced aging of the membrane electrode unit due to regions of the membrane electrode unit only being supplied with an oxidizing agent, it is proposed that the outer border of the anode-side electro-chemically active surface be displaced outwardly at least in sections thereof with respect to the outer border of the cathode-side electro-chemically active surface in a direction running perpendicularly to the stacking direction.

### CROSS-REFERENCE TO RELATED APPLICATIONS

This application is a continuation application of PCT/EP2016/051003, filed on Jan. 19, 2016, which claims priority from German Patent Application No. 10 2015 100 740.1, filed on Jan. 20, 2015, which applications are hereby incorporated in their entirety by reference in this application.

### FIELD OF DISCLOSURE

The present invention relates to an electro-chemical unit for a fuel cell stack in which a plurality of fuel cell units each comprising an electro-chemical unit follow one another along the stacking direction, wherein the electro-chemical unit comprises a membrane electrode unit which comprises an anode-side electro-chemically active surface through which a fuel gas is deliverable to the anode of the membrane electrode unit and which has an outer border that is defined by an anode-side bordering element, and also comprises a cathode-side electro-chemically active surface through which an oxidizing agent is deliverable to the cathode of the membrane electrode unit and which has an outer border that is defined by a cathode-side bordering element.

### BACKGROUND

In fuel cell stacks in which a number of fuel cell units are arranged one above the other in the stacking direction, differing media are fed into different levels of a fuel cell unit and, depending upon the design, are also fed into different regions of the same level. These media can, in particular, be the anode-side fluid (fuel gas), the cathode-side fluid (oxidizing agent) and possibly too, a cooling fluid.

These media being fed through the fuel cell stack may neither mix with one another nor escape from the electro-chemical cells, which is why it is necessary for seals to be provided in a plurality of levels.

Neighbouring electro-chemical units are separated from each other by a separator plate or bipolar plate.

A seal can be inserted into the fuel cell stack as a separate component or can be fixed onto a bipolar plate or onto a component of an electro-chemical unit for a fuel cell unit, for example, onto a gas diffusion layer or onto a membrane electrode unit.

Fixing the seal onto a bipolar plate or onto a gas diffusion layer is frequently preferred because of the advantages in regard to the handling and production thereof and because of the simple implementation of the seal. This can be effected by a process of moulding a seal, in particular one made of an elastomeric material, onto a layer of the bipolar plate or onto a gas diffusion layer for example.

In this configuration of the seal, the combination of the seal fixed to the bipolar plate or to the gas diffusion layer with an edge reinforcing arrangement fixed to the membrane electrode unit (in particular, to a catalyst-coated membrane, CCM) in the boundary region of the membrane electrode unit has proved successful, whereby the edge reinforcing arrangement serves as a counter component for the seal, helps to prevent disadvantageous mechanical stressing of the membrane electrode unit and, at the same time, it ensures advantageous connection of the electro-chemically active region of the membrane electrode unit to the boundary region of the membrane electrode unit.

Such an edge reinforcing arrangement is disclosed in EP 1 403 949 B1 for example.

Such an edge reinforcing arrangement is also referred to as a sub gasket.

Such an edge reinforcing arrangement may comprise one or more layers, whereby, a conventional structure comprises two layers which are arranged on two mutually opposite sides of the membrane electrode unit in the form of a surrounding framework.

During the production of the fuel cell stack, the bipolar plate, the gas diffusion layers, the membrane electrode unit, the seals and if so required, an edge reinforcing arrangement (sub gasket) of each fuel cell unit must be positioned relative to each other, wherein these components can be assembled separately or already be connected to each other to at least a partial extent in the form of sub-assemblies.

When using an edge reinforcing arrangement, an edge reinforcing layer of the edge reinforcing arrangement must be positioned relative to the membrane electrode unit. In the case of a two-piece edge reinforcing arrangement, a second edge reinforcing layer of the edge reinforcing arrangement must also be positioned relative to the membrane electrode unit and/or relative to the first edge reinforcing layer of the edge reinforcing arrangement.

In each case, two gas diffusion layers must be positioned relative to the unit consisting of a membrane electrode unit and the edge reinforcing arrangement.

The unit consisting of a membrane electrode unit and an edge reinforcing arrangement must then be positioned relative to the bipolar plate and the seal, wherein the seal can be applied to the bipolar plate and/or to the edge reinforcing arrangement.

The electro-chemically active regions—as seen in the stacking direction—on both mutually opposing sides (major faces) of the membrane electrode unit (adjoining the anode-side or the cathode-side catalyst layer) in which an electro-chemical reaction can take place are, in dependence on the type of construction, bounded by an edge reinforcing arrangement or bounded by sealing elements which are each in direct contact with the membrane electrode unit and thus prevent a flow of gas to the membrane electrode unit at the anode or at the cathode.

In the case of known fuel cell units, the electro-chemically active surfaces on both sides of the membrane electrode unit, which are defined by the size and/or location of an edge reinforcing arrangement or by seals, are implemented such as to be of nominally equal size and—as seen in the stacking direction—congruent.

Due to manufacturing tolerances of the individual components and the positioning tolerances in the process of assembling the individual components and sub-assemblies, the electro-chemically active regions on the two sides of the membrane electrode unit that are defined by seals or edge reinforcing layers of an edge reinforcing arrangement can, in places, be arranged to be offset relative to each other (in a direction oriented perpendicularly to the stacking direction). Consequently, sections can then occur locally in the boundary region of the membrane electrode unit in which the membrane electrode unit is only covered on one side by an edge reinforcing arrangement or a seal and in which the electro-chemically active region of the membrane electrode unit is supplied with reaction gas from the respectively other side (anode or cathode). If now a region of the membrane electrode unit is only supplied with oxidizing agent, then the missing supply of fuel gas (usually a hydrogen-containing gas) to the membrane electrode unit within this locally limited region can lead to enhanced aging effects. The mechanisms occurring hereby and above all, in regard to the blocking of the gas paths by the partial flooding of the fuel cell with water are treated extensively in the literature, for example, in Electrochemical and Solid-State Letters 9 (4) (2006), pages A183 to A185; in ECS Transactions 3 (1) (2006), pages 811 to 825; and in the International Journal of Heat and Mass Transfer 55 (2012), pages 4745 to 4765.

In particular, the membrane (electrolyte) potential in the under-supplied region decreases due to the regionally-varying inadequate supply of fuel gas and the reduced oxidation of hydrogen at the anode that is associated therewith. The electrode potentials at the anode and at the cathode increase significantly, whereby electro-chemical or chemical damage of the components of the membrane electrode unit can occur.

Consequently, the local blockage of the gas paths at the anode side of the membrane electrode unit in the boundary regions of the anode-side and the cathode-side electro-chemically active surfaces which results from the relative displacement of the seals or the individual layers of the edge reinforcing arrangement within this locally limited region can have an accelerating effect upon the aging of the catalyst layers and the membrane of the membrane electrode unit. Even a displacement of a few tenths of a millimetre can lead to much greater aging in the event of long-lasting operational periods of the fuel cells.

### SUMMARY OF THE INVENTION

The object of the present invention is to provide an electro-chemical unit for a fuel cell stack of the type mentioned hereinabove in which enhanced aging of the membrane electrode unit due to regions of the membrane electrode unit being supplied with only an oxidizing agent is prevented.

In accordance with the invention, this object is achieved in the case of an electro-chemical unit incorporating the features of the first part of Claim 1 in that the outer border of the anode-side electro-chemically active surface of the membrane electrode unit is displaced outwardly at least in sections thereof with respect to the outer border of the cathode-side electro-chemically active surface of the membrane electrode unit in a direction running perpendicularly to the stacking direction.

The concept underlying the present invention is that the electro-chemical unit is deliberately shaped in such a way that the anode-side electro-chemically active region of the membrane electrode unit that is supplied with fuel gas projects laterally at least in sections thereof beyond the cathode-side electro-chemically active region of the membrane electrode unit that is supplied with oxidizing agent. This thereby prevents a region of the membrane electrode unit from being produced that is supplied with oxidizing agent on the cathode-side but is not also being supplied with fuel gas on the anode-side due to manufacturing tolerances of the individual components and/or positioning tolerances in the assembly of individual components and sub-assemblies.

Rather, it is intentionally taken into account that, due to the at least local enlargement of the anode-side electro-chemically active surface of the membrane electrode unit in comparison with the cathode-side electro-chemically active surface of the membrane electrode unit, regions will be produced on the membrane electrode unit which are supplied with fuel gas on the anode-side, but are not also supplied with oxidizing agent on the cathode-side.

The realization underlying this concept is that supplying the membrane electrode unit with fuel gas on just a single-side does not represent a source effective to reinforce the aging mechanisms for the membrane electrode unit and, in regard to the service life of the membrane electrode unit, is to be preferred to the reverse case i.e. the one-sided supply of the membrane electrode unit with oxidizing agent.

The anode-side and cathode-side bordering elements of the electro-chemically active surfaces which outwardly limit the electro-chemically active surfaces of the membrane electrode unit in a plane running perpendicular to the stacking direction are preferably implemented in such a way that the anode-side electro-chemically active surface that is supplied with fuel gas projects laterally beyond the cathode-side electro-chemically active surface that is supplied with oxidizing agent within the region of the displacement and the outer border of the anode-side electro-chemically active surface that is supplied with fuel gas is arranged to be displaced at least in sections thereof relative to the outer border of the cathode-side electro-chemically active surface that is supplied with oxidizing agent in a plane running perpendicularly to the stacking direction.

It is particularly expedient if the outer border of the anode-side electro-chemically active surface is displaced outwardly over at least two thirds of its entire length, in particular over at least 90% of its entire length, and particularly preferred, over substantially its entire length with respect to the outer border of the cathode-side electro-chemically active surface in a direction running perpendicularly to the stacking direction.

Apart from the regions of the membrane electrode unit in which a supply of reaction gases i.e. oxidizing agent and fuel gas to both sides is ensured, there are thus regions in which a supply of fuel gas takes place to only one side, namely, preferably to a peripheral edge of the membrane electrode unit. A local supply of just fuel gas does not however represent a source of enhanced aging mechanisms for the membrane electrode unit.

The components which limit the anode-side electro-chemically active surface and the cathode-side electro-chemically active surface of the membrane electrode unit perpendicularly to the stacking direction and in particular sealing elements and/or edge reinforcing arrangements are implemented in such a manner that even on full utilization of the manufacturing tolerances and assembly tolerances of the components of the electro-chemical unit there will be no region of the membrane electrode unit wherein the cathode-side electro-chemically active surface is larger than the anode-side electro-chemically active surface.

Preferably the preferred size for the offset V through which the outer border of the anode-side electro-chemically active surface is displaced outwardly with respect to the outer border of the cathode-side electro-chemically active surface amounts, at least in sections, to at least approximately 0.1 mm and in particular to at least approximately 0.2 mm over in particular at least 90% of the entire length of these edges and particularly preferred over the entire length of these edges.

In order not to let the region of the membrane electrode unit that is supplied only with fuel gas whereat no electro-chemical reaction takes place from becoming too large, it is expedient if the preferred size for the offset V through which the outer border of the anode-side electro-chemically active surface is displaced outwardly with respect to the outer border of the cathode-side electro-chemically active surface amounts, at least in sections, to at most approximately 0.6 mm and in particular to at most approximately 0.4 mm over preferably at least 90% of the entire length of these edges and in particular over the entire length of these edges.

It is particularly expedient if no point of the outer border of the anode-side electro-chemically active surface is displaced inwardly with respect to the outer border of the cathode-side electro-chemically active surface in a direction running perpendicularly to the stacking direction.

In a special embodiment of the invention, provision is made for the anode-side bordering element and/or the cathode-side bordering element to comprise at least one seal element.

Such a seal element can be fixed to a respectively associated gas diffusion layer or to a bipolar plate.

At least one seal element may comprise at least one connecting region which bounds the anode-side or the cathode-side electro-chemically active surface, and a sealing region which comprises at least one, preferably two or more, sealing lips.

Provision is preferably made for the compressive force with which the connecting region is compressed when assembling the fuel cell stack to amount to less than 50% and in particular to less than 30% of the compressive force with which the entire seal element is compressed when assembling the fuel cell stack.

If the electro-chemical unit comprises an anode-side seal element and a cathode-side seal element, then preferably at least one sealing lip of the anode-side seal element and at least one sealing lip of the cathode-side seal element are arranged at least partly one above the other in the stacking direction.

In a projection along the stacking direction, at least one sealing lip of the anode-side seal element and at least one sealing lip of the cathode-side seal element overlap at least partially, preferably, substantially completely.

As an alternative or in addition thereto, provision may be made for the anode-side bordering element and/or the cathode-side bordering element to comprise at least one edge reinforcing layer, for example, in the form of an edge reinforcing foil.

It is particularly preferred that both the anode-side bordering element and the cathode-side bordering element each comprise an edge reinforcing layer, wherein the edge reinforcing layers are arranged on mutually opposite sides of the membrane electrode unit.

Provision may be made for the anode-side bordering element and/or the cathode-side bordering element to comprise at least one seal element consisting of an elastomeric material or an edge reinforcing foil, wherein the seal element or the edge reinforcing foil bounds the anode-side electro-chemically active surface or the cathode-side electro-chemically active surface.

The anode-side bordering element and/or the cathode-side bordering element can be fixed to a respective gas diffusion layer of the electro-chemical unit, in particular when such a bordering element is a seal element preferably consisting of an elastomeric material.

As an alternative or in addition thereto, provision may be made for at least one anode-side bordering element and/or at least one cathode-side bordering element to be fixed to a bipolar plate and to abut on the membrane electrode unit in the assembled state of the fuel cell stack.

As an alternative or in addition thereto, provision may be made for at least one anode-side bordering element and/or at least one cathode-side bordering element to be fixed to the membrane electrode unit.

Since, in the electro-chemical unit in accordance with the invention, the outer border of the anode-side electro-chemically active surface of the membrane electrode unit is displaced outwardly with respect to the outer border of the cathode-side electro-chemically active surface of the membrane electrode unit, provision can also be made for an anode-side gas diffusion layer of the electro-chemical unit to comprise an outer border which, at least in sections thereof, is displaced outwardly with respect to the outer border of a cathode-side gas diffusion layer of the electro-chemical unit in a direction running perpendicularly to the stacking direction.

Preferably hereby, provision is made for the outer border of the anode-side gas diffusion layer to be displaced outwardly, at least in sections thereof, with respect to the outer border of the cathode-side gas diffusion layer in a direction running perpendicularly to the stacking direction, in particular, over at least 90% of its length and particularly preferred over its entire length.

However, as an alternative thereto, provision may be made for the anode-side gas diffusion layer and the cathode-side gas diffusion layer to be substantially congruent to one another and for the outer borders thereof to lie substantially one above the other as seen in the stacking direction.

In a preferred embodiment of the electro-chemical unit in accordance with the invention, provision is made for the anode-side electro-chemically active surface of the membrane electrode unit to be larger than the cathode-side electro-chemically active surface of the membrane electrode unit.

In particular thereby, the electro-chemical unit is deliberately configured in such a way that the preferred size of the anode-side electro-chemically active region of the membrane electrode unit that is supplied with fuel gas is larger than the cathode-side electro-chemically active region of the membrane electrode unit that is supplied with oxidizing agent.

The electro-chemical unit in accordance with the invention is suitable, in particular, for use in a fuel cell stack which comprises a plurality of electro-chemical units in accordance with the invention that follow one another in the stacking direction.

The membrane electrode unit of the electro-chemical unit in accordance with the invention preferably comprises a polymer electrolyte membrane.

The displacement of the outer borders of the anode-side electro-chemically active surface and of the cathode-side electro-chemically active surface relative to each other is preferably at least as great as the sum of the manufacturing tolerances of the individual components and the assembly tolerances of the individual components relative to each other so that, even when taking into account the manufacturing tolerances and the assembly tolerances, there is no region of the membrane electrode unit in which the cathode-side electro-chemically active surface protrudes beyond the anode-side electro-chemically active surface.

The bordering elements which define the anode-side electro-chemically active surface or the cathode-side electro-chemically active surface of the membrane electrode unit and are preferably in direct contact with the membrane electrode unit can, in particular, be seal elements, edge reinforcing layers and/or mechanical supporting elements.

If an edge reinforcing arrangement comprises just one (preferably cathode-side) edge reinforcing layer in the form of a bordering element which defines one of the electro-chemically active surfaces of the membrane electrode unit (preferably the cathode-side electro-chemically active surface), then the outer border of the other respective electro-chemically active surface of the membrane electrode unit (i.e. preferably the anode-side electro-chemically active surface) is preferably formed by the outer border of the membrane electrode unit itself.

Further features and advantages of the invention form the subject matter of the following description and the graphical illustration of exemplary embodiments.

### BRIEF DESCRIPTION OF THE DRAWINGS

FIG. 1 shows a cut-away longitudinal section through an electro-chemical unit for a fuel cell stack in which a plurality of fuel cell units each comprising an electro-chemical unit follow one another along a stacking direction, and two bipolar plates bordering on the electro-chemical unit, wherein the electro-chemical unit comprises a membrane electrode unit in which the electro-chemically active surfaces are bounded on the anode side and on the cathode side thereof by a respective seal element which is fixed to a gas diffusion layer;

FIG. 2 a cut-away longitudinal section through a second embodiment of an electro-chemical unit for a fuel cell stack in which the electro-chemically active surfaces of the membrane electrode unit are bounded on the cathode side and on the anode side thereof by a respective edge reinforcing foil which is fixed to the membrane electrode unit;

FIG. 3 a cut-away longitudinal section through a third embodiment of an electro-chemical unit for a fuel cell stack in which the electro-chemically active surfaces of the membrane electrode unit are bounded on the anode side and on the cathode side thereof by a respective seal element which is fixed to a gas diffusion layer, wherein connecting regions of the seal elements are not supported by sealing lips and the anode-side gas diffusion layer and the cathode-side gas diffusion layer are preferably formed such as to be substantially congruent; and

FIG. 4 a cut-away longitudinal section through a fourth embodiment of an electro-chemical unit for a fuel cell stack in which the electro-chemically active surfaces are bounded on the anode side and on the cathode side thereof by a respective seal element, wherein connecting regions of the seal elements are supported on the respectively associated bipolar plate by a respective sealing lip and the anode-side gas diffusion layer and the cathode-side gas diffusion layer are preferably formed such as to be substantially congruent.

Similar or functionally equivalent elements are denoted by the same reference symbols in all of the Figures.

### DETAILED DESCRIPTION OF THE INVENTION

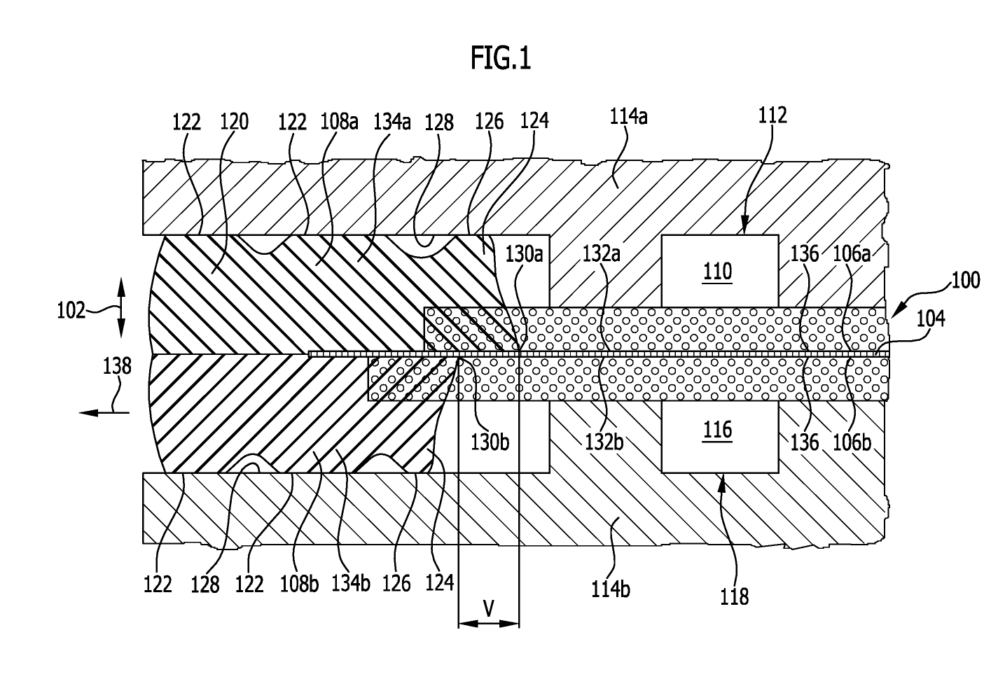

An electro-chemical unit for a fuel cell stack in which a plurality of fuel cell units each comprising an electro-chemical unit 100 which follow one another along a stacking direction 102 is illustrated in cut-away manner in FIG. 1 wherein it is denoted by the general reference 100 and it comprises a membrane electrode unit 104, a cathode-side gas diffusion layer 106a, a cathode-side seal element 108a which is fixed to the cathode-side gas diffusion layer 106a, an anode-side gas diffusion layer 106b and an anode-side seal element 108b which is fixed to the anode-side gas diffusion layer 106b.

The membrane electrode unit 104 comprises a cathode facing the cathode-side gas diffusion layer 106a, an anode facing the anode-side gas diffusion layer 106b and an electrolyte membrane, in particular, a polymer electrolyte membrane which is arranged between the cathode and the anode.

This three-layer construction of the membrane electrode unit 104 is not illustrated in the drawings.

The cathode-side gas diffusion layer 106a is formed from a gas-permeable material and serves for the passage of an oxidizing agent from the channels 110 of a cathode-side flow field 112 of a bipolar plate 114a which follows the electro-chemical unit 100 in the stacking direction 102 and is in contact with the cathode-side gas diffusion layer 106a for the cathode of the membrane electrode unit 104.

The anode-side gas diffusion layer 106b is likewise formed from a gas-permeable material and serves for the passage of a fuel gas from the channels 116 of an anode-side flow field 118 of a bipolar plate 114b which is arranged under the electro-chemical unit 100 in the stacking direction 102 and is in contact with the anode-side gas diffusion layer 106b for the anode of the membrane electrode unit 104.

The seal elements 108a, 108b are formed from an elastomeric material for example.

The seal elements 108a, 108b can be produced, in particular, by an injection moulding process and are preferably bonded to the cathode-side gas diffusion layer 106a and to the anode-side gas diffusion layer 106b, whereby a part of the respectively associated gas diffusion layer 106a, 106b is infiltrated by the seal material.

In the exemplary embodiment illustrated here, each seal element 108a, 108b comprises a respective sealing region 120 having one or more sealing lips 122 as well as a connecting region 124 which preferably comprises a sealing lip 126.

In the assembled state of the fuel cell stack, the sealing lips 122 of the sealing regions 120 and the sealing lips 126 of the connecting regions 124 of the seal elements 108 each abut on a sealing surface 128 of the respectively associated bipolar plate 114a and 114b under a resilient compressive force.

Hereby, the compressive force with which the connecting region 124 of a seal element 108a, 108b is compressed when assembling the fuel cell stack preferably amounts to less than 50% and in particular to less than 30% of the compressive force with which the entire seal element 108a or 108b is compressed when assembling the fuel cell stack.

The connecting region 124 of each seal element 108a, 108b extends through the respectively associated gas diffusion layer 106a and 106b up to the membrane electrode unit 104 where an edge of the seal element 108a, 108b simultaneously forms an outer border 130a of the cathode-side electro-chemically active surface 132a of the membrane electrode unit 104 or an outer border 130b of the anode-side electro-chemically active surface 132b of the membrane electrode unit 104.

The cathode-side electro-chemically active surface 132a of the membrane electrode unit 104 is the surface of the membrane electrode unit 104 through which an oxidizing agent is deliverable to the cathode of the membrane electrode unit 104 from the cathode-side flow field 112 when the fuel cell stack is operational.

This surface is bounded by the cathode-side seal element 108a which thus serves as a cathode-side bordering element 134a in this embodiment.

The anode-side electro-chemically active surface 132b of the membrane electrode unit 104 is the surface of the membrane electrode unit 104 through which a fuel gas is deliverable to the anode of the membrane electrode unit 104 from the anode-side flow field 118 when the fuel cell stack is operational.

This surface is bounded by the anode-side seal element 108b so that the anode-side seal element 108b serves as an anode-side bordering element 134b in this embodiment.

The seal elements 108a, 108b are each located in direct contact with the membrane electrode unit 104 and define the extent of the electro-chemically active surfaces 132a and 132b on the cathode side and on the anode side of the membrane electrode unit 104 respectively.

As can be seen from FIG. 1, the outer border 130b of the anode-side electro-chemically active surface 132b is thereby displaced outwardly i.e. away from the centre of the electro-chemically active surfaces 132a, 132b, by an offset V with respect to the outer border 130a of the cathode-side electro-chemically active surface 132a in a direction 138 running perpendicularly to the stacking direction 102 and parallel to the major faces 136 of the membrane electrode unit 104.

Preferably hereby, the anode-side electro-chemically active surface 132b of the membrane electrode unit 104 is larger than the cathode-side electro-chemically active surface 132a of the membrane electrode unit 104.

A region is thus formed in the outer boundary region of the membrane electrode unit 104 within which the membrane electrode unit 104 is only supplied with a reaction gas from the anode side, but not however from the cathode side.

The effect is thereby achieved that all electro-chemically active regions of the membrane electrode unit 104 are supplied with fuel gas (usually a hydrogen-containing gas) when the fuel cell stack is operational so that an enhanced aging effect due to the failure to supply one region of the membrane electrode unit 104 with fuel gas is prevented.

The nominal offset or preferred offset of the outer borders 130a and 130b relative to one another is preferably somewhat larger than the manufacturing tolerances and assembly tolerances of the individual components of the electro-chemical unit 100 so that even when these tolerance are fully utilized the anode-side electro-chemically active surface 132b is always larger than the cathode-side electro-chemically active surface 132a.

Preferably, provision is made for the offset V between the outer borders 130a and 130b to amount to at least approximately 0.1 mm and in particular to at least approximately 0.2 mm.

Furthermore, in order to ensure that the region of the membrane electrode unit 104 that is only supplied with fuel gas at which no electro-chemical reaction takes place will not be too large, it is expedient if the offset V amounts to at most approximately 0.6 mm and in particular to at most approximately 0.4 mm.

The seal elements 108a and 108b are structured in such a way that as small a total compressive force as possible will be required for building up the compression necessary to achieve an adequate sealing effect.

The seal elements 108a and 108b on the two sides of the membrane electrode unit 104 are preferably formed such as to be substantially congruent so that the lines of application of force to the seal elements 108a, 108b are located substantially one above the other on the anode side and on the cathode side in the stacking direction 102.

In particular, provision is preferably made for the sealing surfaces of the sealing lips 122 of the sealing regions 120 of the seal elements 108a and 108b to overlap at least partially but preferably substantially completely in a projection along the stacking direction 102.

The sealing lips 126 of the connecting regions 124 of the seal elements 108a and 108b can be displaced relative to each other in a direction running perpendicularly to the stacking direction 102 so that the projections of the contact surfaces of the sealing lips 126 do not substantially overlap along the stacking direction 102.

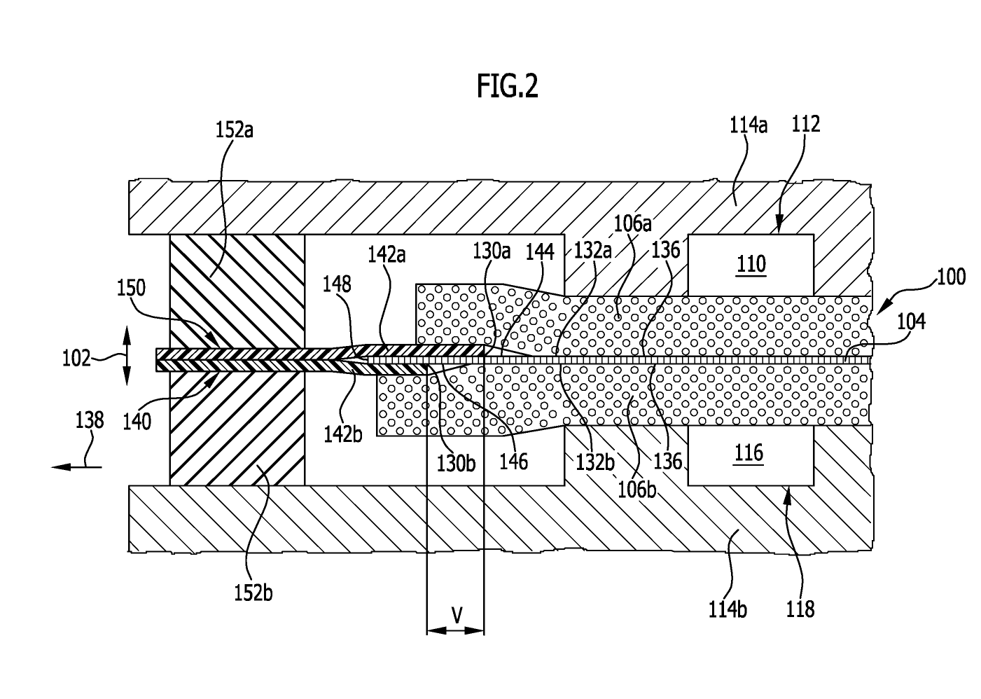

A second embodiment of an electro-chemical unit 100 for a fuel cell stack which is illustrated in cut-away manner in FIG. 2 differs from the first embodiment illustrated in FIG. 1 in that the electro-chemically active surfaces 132a and 132b of the membrane electrode unit 104 are limited at least in sections by an edge reinforcing arrangement 140 which is arranged on the outer border of the membrane electrode unit 104.

Such an edge reinforcing arrangement 104 is also referred to as a sub gasket.

Such an edge reinforcing arrangement 140 may comprise two edge reinforcing layers 142 in the form of edge reinforcing foils for example, wherein a cathode-side edge reinforcing layer 142a abuts on a cathode side 144 of the membrane electrode unit 104, whilst an anode-side edge reinforcing layer 142b abuts on an anode side 146 of the membrane electrode unit 104.

The two edge reinforcing layers 142a and 142b are fixed together preferably by means of a substance-to-substance bond, in particular, by a hot laminating and/or adhesion process in a projection region 150 projecting beyond an outer edge 148 of the membrane electrode unit 104.

Furthermore, provision may be made for the cathode-side edge reinforcing layer 142a to be fixed to the cathode side 144 of the membrane electrode unit 104 preferably by means of a substance-to-substance bond, in particular, by a hot laminating and/or adhesion process, and/or for the anode-side edge reinforcing layer 142b to be fixed to the anode side 146 of the membrane electrode unit 104 preferably by means of a substance-to-substance bond, in particular, by a hot laminating and/or adhesion process.

Each of the edge reinforcing layers 142a, 142b preferably has a thickness of at least approximately 10 μm and preferably of at most approximately 150 μm.

Each of these edge reinforcing layers 142a, 142b can be formed from a thermoplastic, duroplastic or elastomeric polymer which preferably comprises a polytetrafluoroethylene, a polyvinyliden fluoride, a polyester, a polyamide, a copolyamide, a polyamide elastomer, a polyimide, a polyurethane, a polyurethane elastomer, a silicone, a silicone rubber and/or a silicone-based elastomer.

In this embodiment, the outer boundary region of the cathode-side gas diffusion layer 106a is raised above the membrane electrode unit 104 and preferably abuts on a side of the cathode-side edge reinforcing layer 142a that is remote from the membrane electrode unit 104.

In this embodiment, the outer boundary region of the anode-side gas diffusion layer 106b is raised above the membrane electrode unit 104 and preferably abuts on a side of the anode-side edge reinforcing layer 142a that is remote from the membrane electrode unit 104.

The edge of the cathode-side edge reinforcing layer 142a facing the membrane electrode unit 104 simultaneously forms the outer border 130a of the cathode-side electro-chemically active surface 132a of the membrane electrode unit 104.

The edge of the anode-side edge reinforcing layer 142b facing the membrane electrode unit 104 simultaneously forms the outer border 130b of the anode-side electro-chemically active surface 132b of the membrane electrode unit 104.

As can be seen from FIG. 2, the outer border 130b of the anode-side electro-chemically active surface 132b of the membrane electrode unit 104 is displaced outwardly, i.e. away from the centre of the membrane electrode unit 104, by an offset V with respect to the outer border 130a of the cathode-side electro-chemically active surface 132a of the membrane electrode unit 104 in a direction 138 running perpendicularly to the stacking direction 102 of the fuel cell stack and parallel to the major faces 136 of the membrane electrode unit 104.

Preferably, the anode-side electro-chemically active surface 132b of the membrane electrode unit 104 is also larger than the cathode-side electro-chemically active surface 132a of the membrane electrode unit 104 in the second embodiment so that no region of the membrane electrode unit 104 is only supplied with oxidizing agent and enhanced aging effects do not occur in any region of the membrane electrode unit 104.

The membrane electrode unit 104 is mechanically stabilized at the outer boundary region thereof by the edge reinforcing arrangement 140.

The edge reinforcing layers 142a, 142b can each be in the form of a framework surrounding the membrane electrode unit 104.

The size of the overlapping surface of the edge reinforcing layers 142a and 142b on the one hand and the membrane electrode unit 104 on the other is selected to be large enough as to provide a sufficiently large surface for the mechanical connection of the edge reinforcing layers 142a, 142b to the membrane electrode unit 104.

A cathode-side seal element 152a and an anode-side seal element 152b are arranged outside the electro-chemically active surfaces 132a, 132b of the membrane electrode unit 104 and outside the overlapping region between the edge reinforcing layers 142a, 142b and the membrane electrode unit 104.

Hereby, the seal elements 152a, 152b can be fixed to the respectively neighbouring reinforcing layer 142a and 142b and/or to the respectively neighbouring bipolar plate 114a and 114b.

In this second embodiment too, the offset V between the outer border 130b of the anode-side electro-chemically active surface 132b and the outer border 130a of the cathode-side electro-chemically active surface 132a preferably amounts to at least approximately 0.1 mm and in particular to at least approximately 0.2 mm, and preferably to at most approximately 0.6 mm and in particular to at most approximately 0.4 mm.

In all other respects, the second embodiment of the electro-chemical unit 100 that is illustrated in FIG. 2 corresponds in regard to the construction, functioning and method of production thereof with the first embodiment illustrated in FIG. 1, and to that extent reference should be made to the previous description.

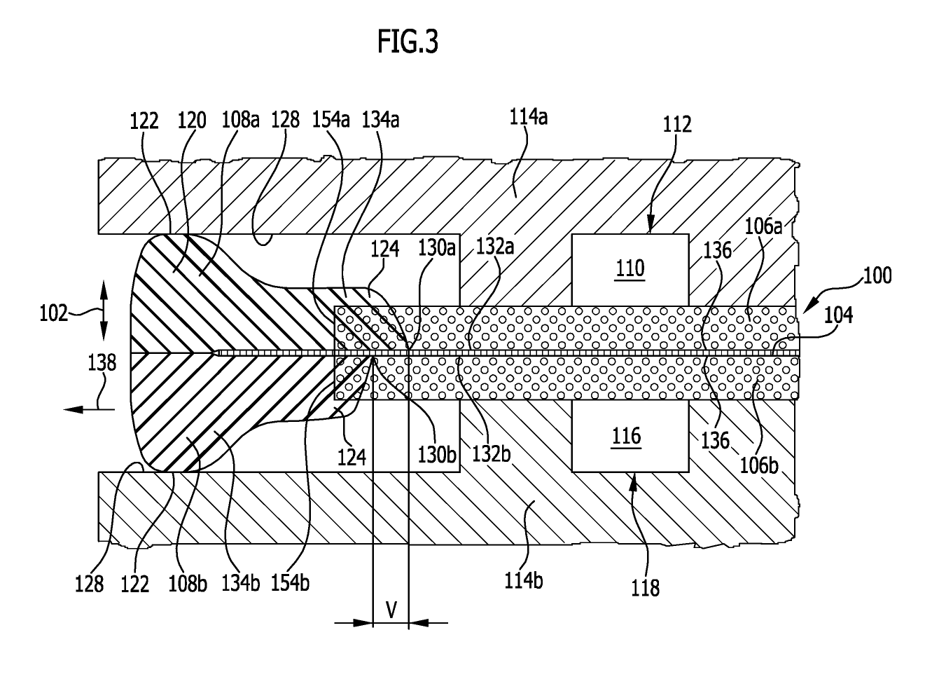

A third embodiment of an electro-chemical unit 100 for a fuel cell stack which is illustrated in cut-away manner in FIG. 3 differs from the first embodiment illustrated in FIG. 1 in that the connecting regions 124 of the seal elements 108a, 108b at which the seal elements 108a, 108b are connected to the cathode-side gas diffusion layer 106a or to the anode-side gas diffusion layer 106b do not comprise sealing lips 126 with which the connecting regions 124 are supported on the respectively neighbouring bipolar plate 114a and 114b.

In this embodiment, the sealing regions 120 of the seal elements 108a, 108b are provided with one or more sealing lips 122 by means of which the sealing regions 120 are supported on the respectively neighbouring bipolar plate 114a and 114b.

Furthermore, in this embodiment the cathode-side gas diffusion layer 106a and the anode-side gas diffusion layer 106b are formed such as to be substantially congruent so that—as seen in the stacking direction 102—the outer borders 154a and 154b of the cathode-side gas diffusion layer 106a or the anode-side gas diffusion layer 106b are located substantially one above the other.

In all other respects, the third embodiment of the electro-chemical unit 100 that is illustrated in FIG. 3 corresponds in regard to the construction, functioning and method of production thereof with the first embodiment illustrated in FIG. 1, and to that extent reference should be made to the previous description.

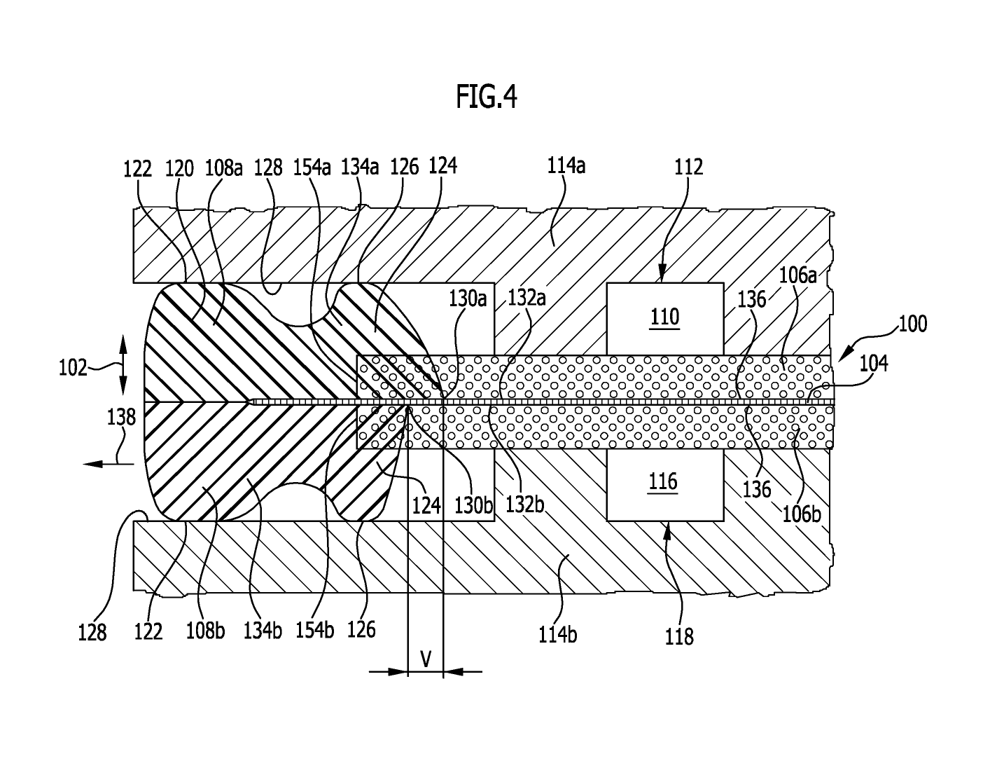

A fourth embodiment of an electro-chemical unit 100 for a fuel cell stack which is illustrated in cut-away manner in FIG. 4 differs from the third embodiment illustrated in FIG. 3 in that in the case of the fourth embodiment each of the connecting regions 124 of the seal elements 108a, 108b are also provided with at least one sealing lip 126, wherein the respective connecting region 124 is supported via the respective sealing lip 126 on the respectively neighbouring bipolar plate 114a and 114b as was the case in the first embodiment illustrated in FIG. 1.

In the fourth embodiment however, provision is preferably made for the sealing surfaces of the sealing lips 126 of the connecting regions 124 of the seal elements 108a, 108b to overlap each other at least partly and preferably substantially completely in a projection along the stacking direction 102.

In the case of the fourth embodiment, the cathode-side gas diffusion layer 106a and the anode-side gas diffusion layer 106b are also preferably formed such as to be substantially congruent and—as seen along the stacking direction 102—the outer borders 154a and 154b of the cathode-side gas diffusion layer 106a and the anode-side gas diffusion layer 106b preferably lie substantially one above the other.

In all other respects, the fourth embodiment of the electro-chemical unit 100 that is illustrated in FIG. 4 corresponds in regard to the construction, functioning and method of production thereof with the first embodiment illustrated in FIG. 1, and to that extent reference should be made to the previous description.

1. An electro-chemical unit for a fuel cell stack in which a plurality of fuel cell units each comprising an electro-chemical unit follow one another along a stacking direction, comprising:
a membrane electrode unit which comprises an anode-side electro-chemically active surface through which a fuel gas is deliverable to an anode of the membrane electrode unit and which has an outer border that is defined by an anode-side bordering element, and also comprises a cathode-side electro-chemically active surface through which an oxidizing agent is deliverable to a cathode of the membrane electrode unit and which has an outer border that is defined by a cathode-side bordering element,
wherein the outer border of the anode-side electro-chemically active surface is displaced outwardly at least in sections thereof with respect to the outer border of the cathode-side electro-chemically active surface in a direction running perpendicularly to the stacking direction.

2. The electro-chemical unit in accordance with claim 1, wherein the outer border of the anode-side electro-chemically active surface is displaced outwardly over substantially its entire length with respect to the outer border of the cathode-side electro-chemically active surface in a direction running perpendicularly to the stacking direction.

3. The electro-chemical unit in accordance with claim 1, wherein the offset through which the outer border of the anode-side electro-chemically active surface is displaced outwardly with respect to the outer border of the cathode-side electro-chemically active surface amounts, at least in sections thereof, to at least 0.1 mm.

4. The electro-chemical unit in accordance with claim 1, wherein the offset through which the outer border of the anode-side electro-chemically active surface is displaced outwardly with respect to the outer border of the cathode-side electro-chemically active surface amounts to at most 0.6 mm.

5. The electro-chemical unit in accordance with claim 1, wherein no point of the outer border of the anode-side electro-chemically active surface is displaced inwardly with respect to the outer border of the cathode-side electro-chemically active surface in a direction running perpendicularly to the stacking direction.

6. The electro-chemical unit in accordance with claim 1, wherein the anode-side bordering element and/or the cathode-side bordering element comprises at least one seal element.

7. The electro-chemical unit in accordance with claim 1, wherein at least one seal element comprises at least one connecting region which bounds the anode-side electro-chemically active surface or the cathode-side electro-chemically active surface and has a sealing region which comprises at least one sealing lip.

8. The electro-chemical unit in accordance with claim 7, wherein the compressive force with which the connecting region is compressed when assembling the fuel cell stack amounts to less than 50% of the compressive force with which the entire seal element is compressed when assembling the fuel cell stack.

9. The electro-chemical unit in accordance with claim 7, wherein the electro-chemical unit comprises an anode-side seal element and a cathode-side seal element, wherein at least one sealing lip of the anode-side seal element and at least one sealing lip of the cathode-side seal element are arranged at least partly one above the other in the stacking direction.

10. The electro-chemical unit in accordance with claim 1, wherein the anode-side bordering element and/or the cathode-side bordering element comprises at least one edge reinforcing layer.

11. The electro-chemical unit in accordance with claim 1, wherein the anode-side bordering element and/or the cathode-side bordering element comprises at least one seal element made of an elastomeric material or an edge reinforcing foil,
wherein the seal element or the edge reinforcing foil bounds the anode-side electro-chemically active surface or the cathode-side electro-chemically active surface.

12. The electro-chemical unit in accordance with claim 1, wherein the anode-side bordering element and/or the cathode-side bordering element is fixed to a gas diffusion layer of the electro-chemical unit.

13. The electro-chemical unit in accordance with claim 1, wherein the anode-side bordering element and/or the cathode-side bordering element is fixed to a bipolar plate and abuts on the membrane electrode unit in the assembled state of the fuel cell stack.

14. The electro-chemical unit in accordance with claim 1, wherein the anode-side bordering element and/or the cathode-side bordering element is fixed to the membrane electrode unit.

15. The electro-chemical unit in accordance with claim 1, wherein the anode-side electro-chemically active surface of the membrane electrode unit is larger than the cathode-side electro-chemically active surface of the membrane electrode unit.

16. A fuel cell stack comprising a plurality of electro-chemical units which follow one another in a stacking direction, wherein each of the electro-chemical units comprises a membrane electrode unit which comprises an anode-side electro-chemically active surface through which a fuel gas is deliverable to an anode of the membrane electrode unit and which has an outer border that is defined by an anode-side bordering element, and also comprises a cathode-side electro-chemically active surface through which an oxidizing agent is deliverable to a cathode of the membrane electrode unit and which has an outer border that is defined by a cathode-side bordering element,
wherein the outer border of the anode-side electro-chemically active surface is displaced outwardly at least in sections thereof with respect to the outer border of the cathode-side electro-chemically active surface in a direction running perpendicularly to the stacking direction.
